(19) United States
(12) Patent Application Publication
(10) Pub. No.: US 2009/0165667 A1
(43) Pub. Date: Jul. 2, 2009

(54) Apparatus and method for electromagnetic levitation on an uncharged and non-magnetized arbitrary surface

(76) Inventor: Anthony Emeka Nwankwo, Dallas, TX (US)

Correspondence Address: ANTHONY EMEKA NWANKWO, APT#148, 7740 McCALLUM BLVD, DALLAS, TX, 75252, US

(21) Appl. No.: 12/005,554

(22) Filed: Dec. 27, 2007

(51) Int. Cl. B60L 13/04

(52) U.S. Cl. 104/281

(57) ABSTRACT

Methods and systems for levitation on uncharged and non-magnetized arbitrary surface are disclosed. The system comprises a stack of conducting power plates, a high frequency high voltage (HFHV) source, a force feedback step-up transformer (FFST) and an uncharged and non-magnetized arbitrary surface. The secondary coils of the FFST charge a stack of conducting power plates. The charged conducting power plates switch its polarity in a controlled manner. Due to kinetic inertia of the effective dipole moment of the uncharged and non-magnetized arbitrary surface, the dipole moment cannot maintain the changes in response to the changes in polarity of the stack of conducting power plates and thus, a repulsive force is generated between the stack of conductive power plates and the non-magnetized arbitrary surface. The controlled repulsive force initiates and maintains the desired level of levitation with respect to the uncharged and non-magnetized arbitrary surface.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Technical Field

This disclosure relates to an electromagnetic apparatus and operation of a levitation vehicle. More specifically, it relates to an electromagnetic levitation vehicle, which operates on an uncharged and non-magnetized arbitrary surface.

2. Background

Since several decades, levitation systems have been used in a variety of industrial and other applications. For example, magnetic levitation systems have been used for railroad trains, steel structures etc.

There are several issued patents and published application. For example, a published application No. US 2001/0045311 A1 describes a control levitation vehicle, which uses rope shuttles where the vehicle is towed by a rope, and a linear shuttle where the vehicle is driven by a linear motor.

U.S. Pat. No. 5,319,336 issued to Andrew R. Alcon, discloses a magnetic levitation system for a stable or rigid levitation of a body. The object to be levitated is maintained in an equilibrium position above a flat guideway or plurality of continuous guideways.

The prior art indicates that no levitation system has been developed with the capability to levitate on an uncharged and non-magnetized arbitrary surface.

### SUMMARY OF THE INVENTION

Methods and systems for levitation on uncharged and non-magnetized arbitrary surface are disclosed. The system includes a stack of conducting power plates, high frequency high voltage source (HFHV), force feedback step-up transformer (FFST). The FFST charges a stack of conducting power plates. The charged stack of conducting power plates switch its polarity in a rapid and controlled manner and due to kinetic inertia of the dipole moment of the uncharged and non-magnetized surface, the dipole fails to maintain the change in polarity of the conducting power plates and therefore, a repulsive force is generated. The repulsive force can initiate and maintain the levitation on an uncharged and non-magnetized surface in a desired controlled manner. This phenomenon is repeated on continuous basis throughout the levitation process.

In a preferred embodiment of the present innovations, the levitation on an uncharged and non-magnetized surface can be achieved by controlling the electric field in the stack of conductive power plates by a force feedback step-up transformer. In this embodiment, the electric field is generated from the bottom of the stack of conductive plates facing down to the direction of an uncharged and non-magnetized surface, and the levitation can be achieved in both an upward and the downward direction.

In another embodiment, the electric field can be generated both from the top and bottom of stack of conductive plates, and the levitation can be achieved both in an upward and the downward direction.

In another embodiment, the levitation can be achieved by using a capacitor control, which is an alternate force feedback step-up transformer. A force sensor controls the capacitor to increase or decrease to rapidly switch the polarity of the conducting power plates and thus the resulting repulsion, which initiate and maintains the desired level of levitation.

The benefits of the present innovations can include: the ability of the system to levitate above any arbitrary surface without preconditioning the surface (uncharged and non-magnetized). Elimination of expenses to prepare a preconditioned surface and also, appreciable energy savings by eliminating the energy required to prepare for the preconditioned surfaces.

As discussed above, the newly disclosed innovations overcome the disadvantages inherent in the prior art. It is to be understood that this disclosure is not limited in its details of construction. Additionally, it is to be understood that phraseology and terminology employed herein are for the purpose of description and should not be regarded as limiting.

Accordingly, those skilled in the art will appreciate that the concept upon which these innovations are based can be readily utilized for the design of other devices for carrying out the purposes of these present innovations. Therefore, it should also be realized by those skilled in the art that such equivalent constructions do not depart from the spirit and scope of the disclosure as set forth in the appended claims.

### BRIEF DESCRIPTION OF THE DRAWINGS

FIG. 1 shows a block diagram for the electromagnetic levitation vehicle system.

FIG. 2 shows a schematic for the force feedback step-up transformer (FFST).

FIG. 3(a) shows a stack-up of conducting power plates for the electromagnetic levitation vehicle.

FIG. 3(b) illustrates a charging mechanism for the conducting power plates.

FIG. 4 shows an alternate arrangement a stack-up of conducting power plates.

FIG. 5 shows an alternate arrangement for the force feedback setup transformer (FFST).

### DETAILED DESCRIPTION OF THE DRAWINGS

The numerous innovative teachings of present application will be described with particular reference to presently preferred embodiments.

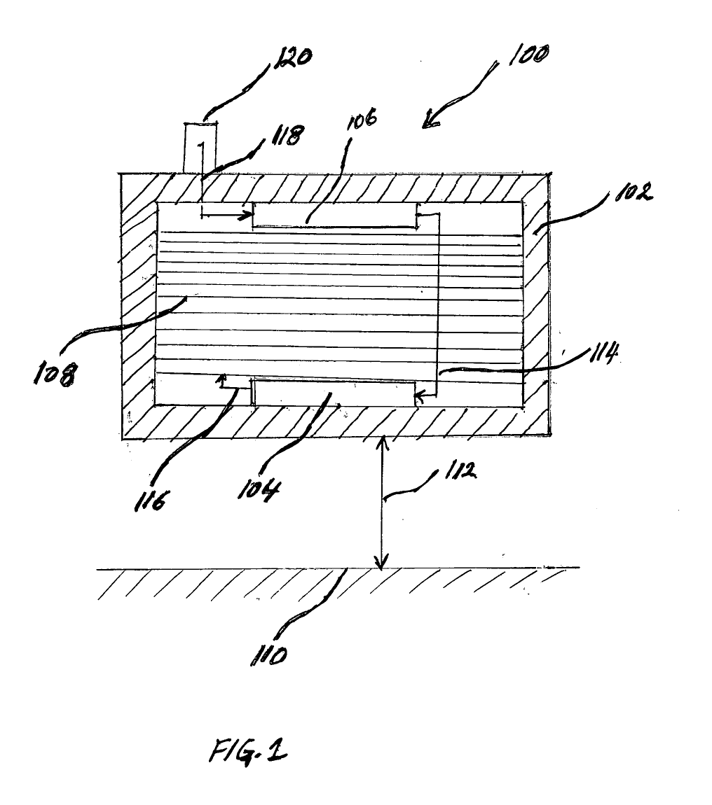

Referring now to drawings, FIG. 1 shows a block diagram of an electromagnetic levitation device 100. The device 100 comprises a chassis 102, which houses the device 100. A force feedback step-up transformer (FFST) 104. The FFST 104 controls a high frequency high voltage power source (HFHV) 106, a stack of power plates 108. The HFHV has frequency, which is controlled by the FFST 106. The HVHF 106 transmits power to the stack of power plates 108. The stack of power plates 108 generates an electric field. The FFST 104 controls the frequency of the electric field from the stack of conductive power plates 108 in such a manner that the device 100 remains levitated from the uncharged and non-magnetized arbitrary surface 110. The levitation height 112 between the chassis 102 and the uncharged and non-magnetized arbitrary surface is about 30 feet. The lead to primary coil in from HFHV 106 to FFST 104 is shown by a connection lead 114. The secondary coils from FFST 104 to the conductive power Plates 108 is shown by the leads 116. The operation of device 100 can be controlled by signals from 118 to HFHV 106 by control box 120. The levitation is achieved by controlling the electric field in the stack of conductive power plates 108 by the FFST 104 depending upon the induced polarization of the uncharged and non-magnetized arbitrary surface 110.

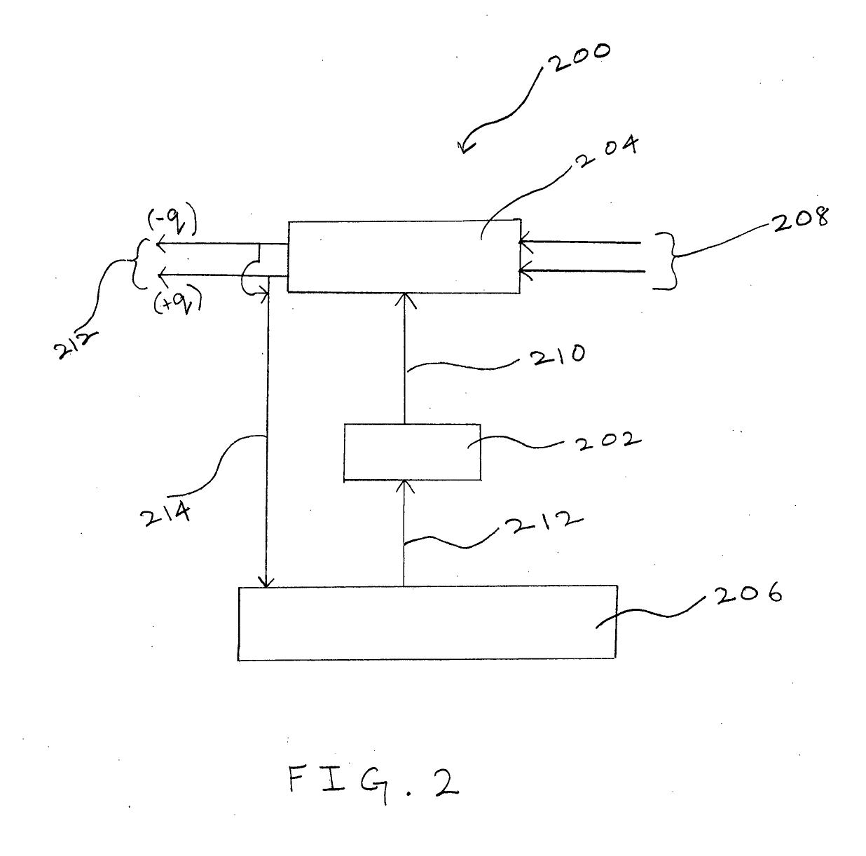

FIG. 2 shows a schematic 200, which shows details for the force feedback step-up transformer (FFST) as described in FIG. 1. The FFST comprises a frequency control 202. The frequency control 202 regulates frequency at which high voltage oscillates by transmitting signals that change the permeability of a variable permeability transformer (VPST) 204. The signals sent to VPST 204 depend on the output of a force sensor 206. When a repulsive force is sensed by the force sensor 206, the frequency of VPST 204 decreases so as to maintain the charge polarity on the power plate, which will generate repulsion from the uncharged and non-magnetized arbitrary surface 110 (FIG. 1). When attractive or neutral force are sensed by the force sensor 206, it prompts the frequency control 202 to increase the frequency of VPST 204 and thereby to rapidly switch the charge polarity of the conductive power plates 108 (FIG. 1). The input leads 208 to VPST 204 are from HFHV 106 (FIG. 1), and frequency control 202 feeds signals 210 to VPST 204. The leads 212 are from secondary coil of VPST 204 to stack up of conductive power plates 108 (FIG. 1). The force sensor feed forward signal 214 is from secondary coil of VPST 204 to the force sensor 206. The force sensor feed forward signal 214 determines the nature of the force, which can be attractive, repulsive or neutral.

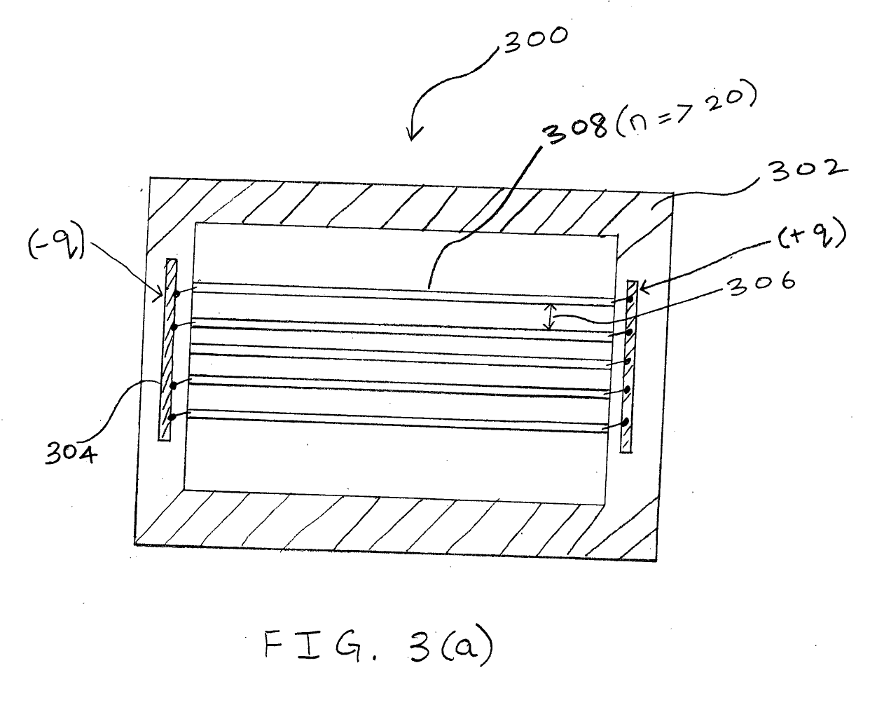

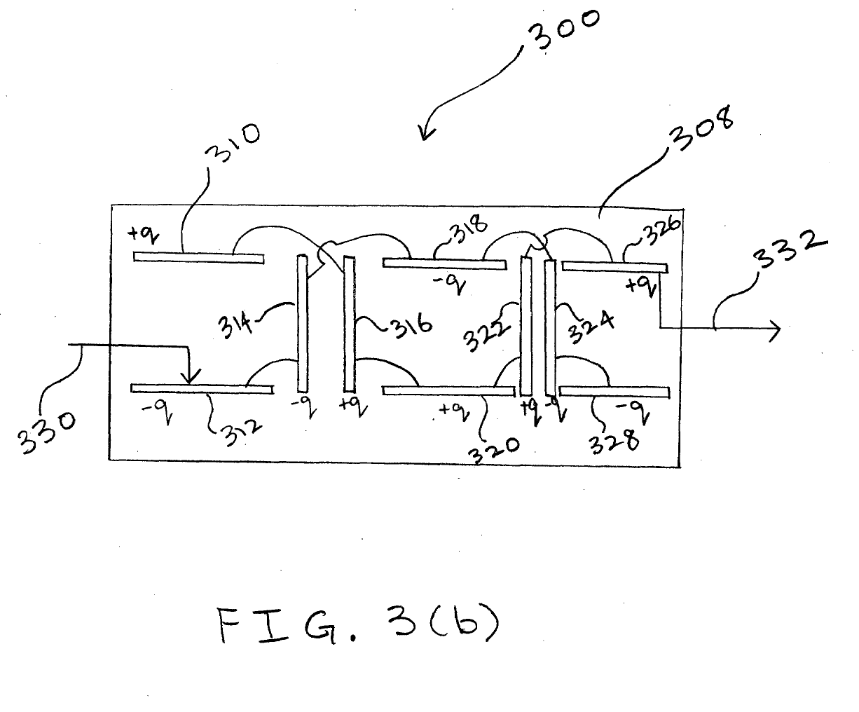

FIG. 3(a) shows a cross sectional view 300 for a stack-up of conducting power plates for the levitation vehicle. The cross sectional view comprises an engine chassis 302, a stack-up of conductive power plates 308, and conductors 304, 306 for the electromagnetic levitation vehicle. In a preferred embodiment of the present innovations, the number of conductive power plates 308 can be about 20 (n=20). The gap 306 between the power plates is about 1.0 inch. The stack of conductive power plates 308 are connected to conductors 304, 306 through electrical connections (308) (n=20) and the corresponding connecting leads (n=20) for each conductor. The conductor 304 and 306 are of opposite polarity depending on the output from the FFST 104 (FIG. 1). The polarity of stack of conductive power plates 308 is changed in a such a controlled manner that a repulsive force between the uncharged and non-magnetized arbitrary surface 110 (FIG. 1) and the stack of conductive power plates initiates levitation of the conductive power plates and the chassis 102 (FIG. 1) to which it is attached. This embodiment will have fields only from the parts facing towards the uncharged and non-magnetized arbitrary surface 110 (FIG. 1).

FIG. 3(b) illustrates a schematic 300, which comprises single power plate 308 (FIG. 3(a), thin metal foils 310-326, the corresponding leads that connect thin metal foils arranged in Halbach configuration, connecting leads 330 (with negative charge) and 332 (with positive charge) from the secondary coils from VPST 204 (FIG. 2). The thin metal plates 310-328 can be Aluminum with a thickness of about 0.5 inch and length of about 15 feet. The schematic 300 illustrates the charge mechanism for the single power plate 308. The charge is switched between positive to negative charge at a rate, which initiates the levitation.

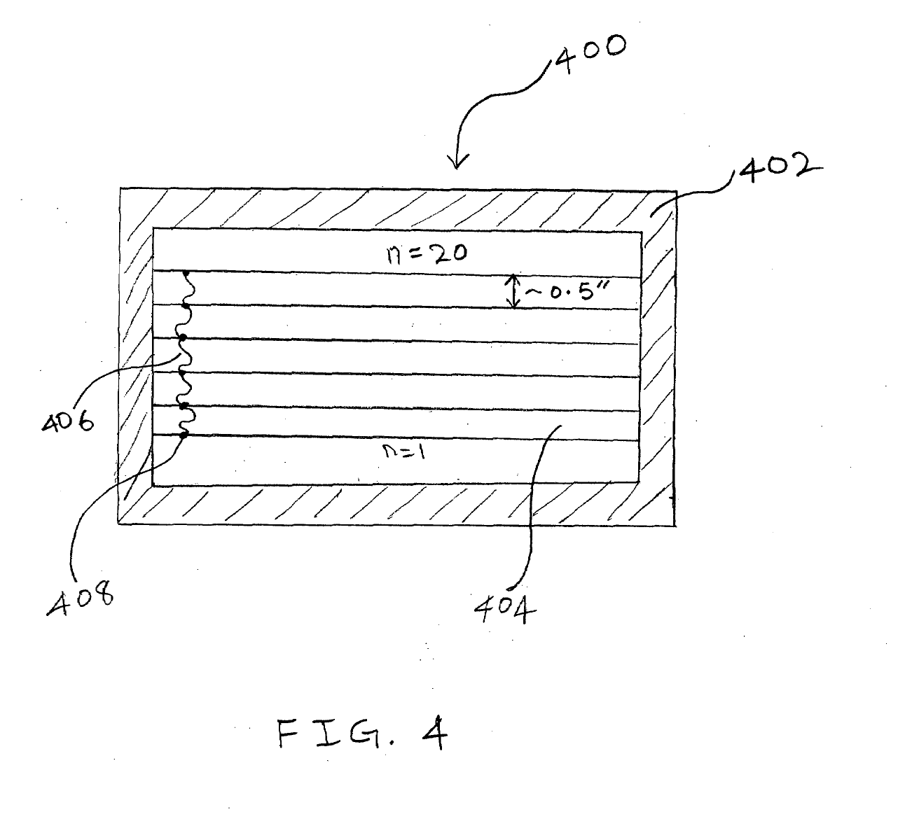

FIG. 4 shows an alternate arrangement 400 of a stack-up of conducting power plate 400. The alternate arrangement comprises the chassis 402, a set of about twenty conducting power plates 404. The conductor 606 and the lead (−q) 408 connect to the secondary coil of VPST 204 (FIG. 2). The chassis 402 supports the conducting power plates 404. The conducting power plate 404 material can be Aluminum. This embodiment, unlike FIG. 3(a), can have the electric field generated both from the top and bottom of stack up of conducting power plates.

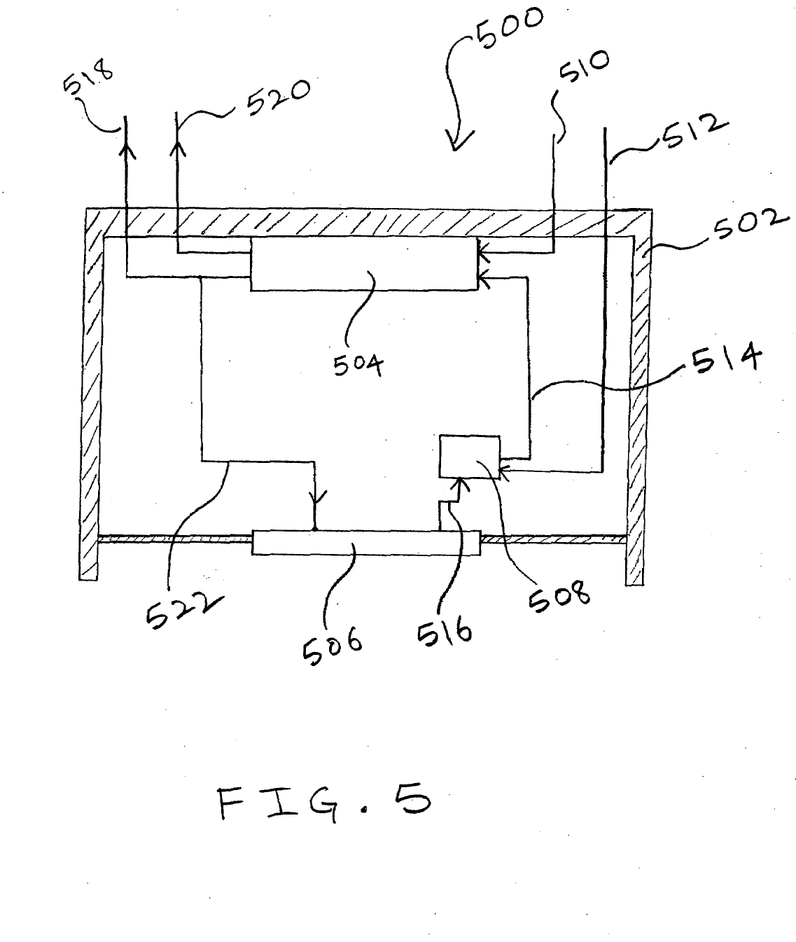

FIG. 5 shows an alternate arrangement 500 for the force back step-up transformer (FFST). The arrangement 500 comprises a chassis 502, force back step-up transformer 504, force sensor 506, control capacitor 508, connecting leads 510, 512 from HFHV generator (not shown in FIG. 5) to FFST 504 and 514. The connecting lead 516 to control capacitor 508, leads 518 and 520 from secondary coil of FFST 504 to HFHV generator and lead 522 to the force sensor 506. In this embodiment, output from secondary coil of FFST 504 is controlled by the control capacitor 508. The force sensor 506 controls the capacitor 508. When there is no repulsion, the capacitance is reduced by the force sensor, thereby increasing the frequency and rapidly switching the conducting power plate (not shown in FIG. 5) polarity that will generate repulsion. If there is repulsion, the capacitance is increased, thereby decreasing the frequency of the secondary output, and thus maintaining the desired repulsion.

What is claimed is:

1. A method for levitating a vehicle, comprising the actions of:
using a high frequency high voltage source;
using a force feedback step-up transformer; and
generating a repulsive force between an electrically charged a stack of conducting power plates and an uncharged and non-magnetized arbitrary surface.

2. The method of claim 1, wherein the conducting power plates material can be Aluminum.

3. The method of claim 2, wherein the number of conducting power plates can be between 15-20.

4. The method of claim 3, wherein thickness of the conducting power plate can be about 1.0 inch.

5. The method of claim 4, wherein gap between each of the conduction power plate can be between 0.5-1.0 inch.

6. The method of claim 5, wherein the stack of conducting plates can generate electric field towards the bottom of the plates facing the uncharged and non-magnetized arbitrary surface.

7. The method of claim 6, wherein the stack of conducting power plates can generate electric field towards the bottom and the top of the plates.

8. The method of claim 7, wherein the levitation vehicle can be operated in the upward and the downward direction facing the uncharged and non-magnetized arbitrary surface.

9. The method of claim 8, wherein the uncharged and non-magnetized surface can be a conducting or non-conducting surface.

10. The levitation vehicle of claim 1, wherein the force feedback step-up transformer can measure the force between the stack of conduction power plates and the uncharged and non-magnetized arbitrary surface and can rapidly change the polarity of the power plates to initiate and maintain the desired level of levitation.

11. The levitation vehicle of claim 10, wherein the conducting power plates can be thin foils.

12. The levitation vehicle of claim 11, wherein the number of the thin foils can be between 15-20.

13. The levitation vehicle of claim 12, wherein the thin foils can be Aluminum.

14. The levitation vehicle of claim 13, wherein the thin foils thickness can be about 0.25 inch.

15. The levitation vehicle of claim 1, wherein a control capacitor can be used to control the level of levitation of the levitation vehicle.

16. The levitation vehicle of claim 1, wherein the operating ranges of the levitation vehicle can be about 30 feet in height.
